(19) United States
(12) Patent Application Publication
(10) Pub. No.: US 2014/0188916 A1
(43) Pub. Date: Jul. 3, 2014

(54) COMBINING ODATA AND BPMN FOR A BUSINESS PROCESS VISIBILITY RESOURCE MODEL

(71) Applicants: Oliver Kieselbach, Bielefeld (DE); Bernd Otte, Linkenheim-Hochstetten (DE)

(72) Inventors: Oliver Kieselbach, Bielefeld (DE); Bernd Otte, Linkenheim-Hochstetten (DE)

(73) Assignee: SAP AG, Walldorf (DE)

(21) Appl. No.: 13/733,563

(22) Filed: Jan. 3, 2013

(51) Int. Cl. G06F 17/30

(52) U.S. Cl. CPC G06F 17/30386
USPC 707/755

(57) ABSTRACT

The present disclosure describes methods, systems, and computer program products for providing a business process visibility resource model. One computer-implemented method includes receiving a request for process data from a client device, parsing the received request to determine a type of process data to return and to recover request parameters, determining the type of process data requested, accessing a process resource model and retrieving process data based upon the recovered request parameters, generating a response returning data in a format compliant with the type of process data requested, and transmitting the generated response data.

### BACKGROUND

The present disclosure relates to computer-implemented methods, computer-readable media, and computer systems for providing a business process visibility resource model. Business processes are typically implemented in various ways making it difficult to define, implement, observe, maintain, and/or optimize the business processes. For example, the business processes can be implemented as intrinsic application processes, in an embedded workflow, and as driven by particular process engines. The business processes are also difficult to consume. The inability to provide a consistent implementation and consumption methodology for business processes results in at least a higher cost of business process ownership, inefficiency, unneeded complexity and training, inherent incompatibility between the various business process implementations, and the need to develop custom/particular business process interface and usage solutions.

### SUMMARY

The present disclosure relates to computer-implemented methods, computer-readable media, and computer systems for providing a business process visibility resource model. One computer-implemented method includes receiving a request for process data from a client device, parsing the received request to determine a type of process data to return and to recover request parameters, determining the type of process data requested, accessing a process resource model and retrieving process data based upon the recovered request parameters, generating a response returning data in a format compliant with the type of process data requested, and transmitting the generated response data.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the type of process data is one of process instance data or process definition data.

A second aspect, combinable with any of the previous aspects, wherein the process resource model is an OData-based consumption entity model including a BPMN media link.

A third aspect, combinable with any of the previous aspects, further comprising: requesting process definition data using a BPMN media link attribute; and receiving BMPN-compliant response data.

A fourth aspect, combinable with any of the previous aspects, wherein the determination of the type of process data requested results in process instance data.

A fifth aspect, combinable with any of the previous aspects, further comprising generating an OData-compliant response to the received request.

A sixth aspect, combinable with any of the previous aspects, wherein the determination of the type of process data requested results in process definition data.

A seventh aspect, combinable with any of the previous aspects, further comprising generating a BPMN-compliant response to the received request.

The subject matter described in this specification can be implemented in particular implementations so as to realize one or more of the following advantages. First, consistent implementation and/or consumption of business processes through a business process visibility resource model, allows a more generic interface and consumption methods to be designed and implemented in order to permit easier and consistent access to and/or consumption of business processes. As one result, the total cost of ownership for business processes is reduced. Additionally, inherent incompatibility is reduced between various business process implementations leveraging a particular business process visibility resource model. Second, simplified training programs can be devised and offered to prepare others to access and/or consume business processes. Third, the business process visibility resource model allows reuse of interface and consumption aspects of the business process visibility resource model. One benefit of the permitted reuse is to more efficiently leverage prior work to minimize the unnecessary expenditure of financial resources to develop particular access and/or consumption solutions for different business processes. Fourth, the business process visibility resource model permits development tools to leverage the business process visibility resource model in order to create, maintain, modify, and/or delete applications/business processes of varying types, for example web applications, mobile applications, etc. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing a business process visibility resource model.

FIGS. 2A-2C are block diagrams illustrating an example process resource model according to one implementation.

FIG. 3 is a flow chart illustrating a method for interfacing and obtaining process data from a process resource model.

Like reference numbers and designations in the various drawings indicate like elements.

### DETAILED DESCRIPTION

This disclosure generally describes computer-implemented methods, computer-program products, and systems for providing a business process visibility resource model.

Open Data Protocol (OData) is a web protocol for querying and updating data over networks and allows for a user to request data from a data source over the Hypertext Transfer Protocol and receive results back from the data source in formats such as Atom Publishing Protocol (Atom), Javascript Object Notation (JSON), and Extensible Markup Language (XML), etc. In some implementations, the request may be divided into multiple segments. In some implementations, the multiple request segments may made and/or received concurrently and/or in parallel. The OData protocol is increasingly used by mobile computing and other computing platforms, such as smartphones and tablet computers, as an important method of access to information over networks.

Business Process Model and Notation (BPMN) is a type of graphical representation used for specifying business processes, for example in a business model Business Process Diagram (BPD). BPMN notation is designed to be intuitive to business users as well as capable of representing complex process semantics and provides a mapping between the graphics of the notion and the underlying constructs of execution languages.

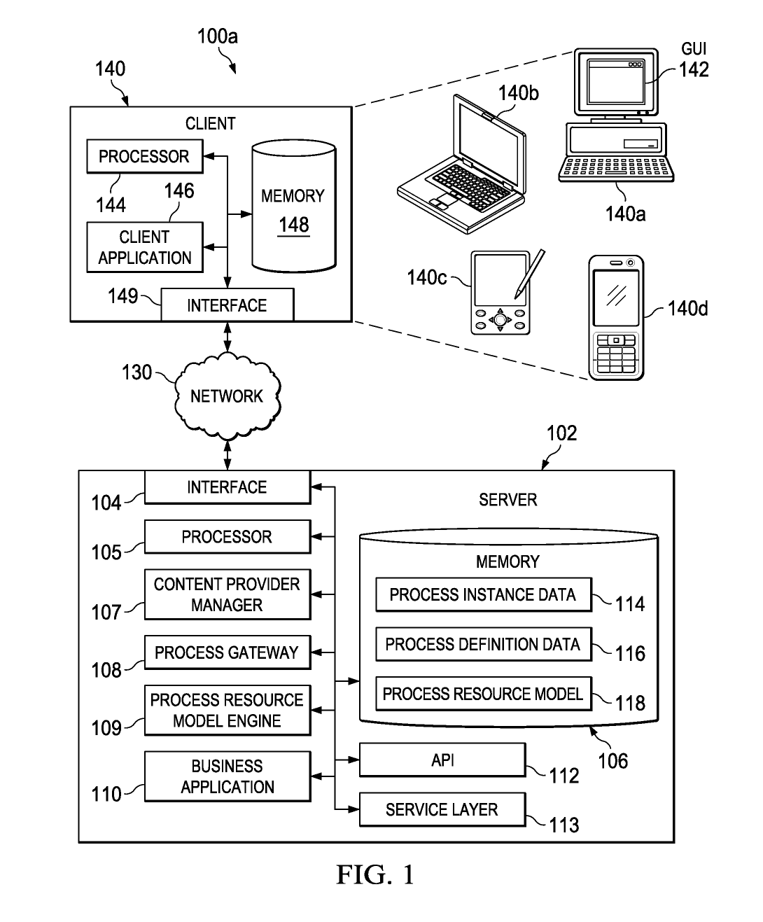

FIG. 1 is a block diagram illustrating an example distributed computing system 100 for providing a business process visibility resource model. The illustrated example distributed computing system 100 includes or is communicably coupled with a server 102 and a client 140 that communicate across a network 130 (described below). At a high level, the server 102 is an electronic computing device operable to receive, transmit, process, store, or manage data and information associated with the example distributed computing system 100. According to some implementations, server 102 may also include or be communicably coupled with an e-mail server, a web server, a caching server, a streaming data server, and/or other suitable server. The following described computer-implemented methods, computer-readable media, computer systems, and components of the example distributed computer system 100 provide functionality through one or more graphical user interfaces (GUIs) providing an efficient and user-friendly presentation of data provided by or communicated within the example distributed computing system 100.

In general, the server 102 is a server that stores one or more business applications 110, where at least a portion of the business applications 110 are executed using requests and responses sent by clients 140 within and communicably coupled to the illustrated example distributed computing system 100. In some implementations, the server 102 may store a plurality of various business applications 110. In other implementations, the server 102 may be a dedicated server meant to store and execute only a single business application 110. In some implementations, the server 102 may comprise a web server, where the business applications 110 represent one or more web-based applications accessed and executed by the client 140 using the network 130 or directly at the server 102 to perform the programmed tasks or operations of the business application 110. The server 102 allows a user to access process definition and/or process instance data about business processes associated with and executing in conjunction with a particular business application 110.

The server 102 provides a process gateway 108 that can be any application, program, module (hardware and/or software), process (e.g., a development tool), or other software that enables communication between business processes and external programs (including the business application 110) as well as communication between business process instances associated with other distributed computing systems. In some implementations, the process gateway 100 provides an application programming interface (API) allowing a user and/or process to request and consume design-time and/or runtime process data in a uniform manner through the use of a non-secure/secure hypertext transfer protocol (HTTP) request. As will be appreciated by those skilled in the art, HTTP is one of a myriad possible ways of formatting and generating a suitable request. The exemplary use of HTTP(S) is not meant to be limiting in any way. From the perspective of a process gateway 108 user, an HTTP requests can be formatted in such a manner to allow receipt of data pertaining to both one or more process definitions and/or one or more process instances, thus making it possible for users to create business applications that operate on end-to-end business processes. The HTTP request formatting allows a process gateway 108 user to query, filter, and navigate to other entities associated with a business process as defined by a process resource model 118, process instance data 114, and or process definition data 116.

For example, HTTP requests for run-time process instance data could include:
a. Get all available process instances: http://server/servicename/ProcessCollection
b. Search for process instances adhering to certain filter criteria (status, timeframe, etc.):
   http://server/servicename/ProcessCollection?$filter=Status %20eq %20‘Complete d’
   http://server/servicename/ProcessCollection?$filter=StartTimestamp %20ge%20‘ . . . ’%20and%20 . . . .
c. Get all process instances to a given process definition (with optional filters):
   http://server/servicename/ProcessDefinitionCollection(Id=‘1234’)/Process http://server/servicename/ProcessDefinitionCollection(Id=‘1234’)/Process?$filter=Status %20 . . . .

Further, HTTP(S) requests for design-time process definition data could include:
a. Get all available process definitions:
   http://server/servicename/ProcessDefinitionCollection
b. Search for process definition adhering to certain filter criteria (Process Family, Description, etc.):
   http://server/servicename/ProcessDefinitionCollection?$filter=ProcessFamiliyID %20eq %20‘ . . . . ’
c. Get process definition for a certain process instance:
   http://server/servicename/ProcessCollection(Id=‘1234’)/ProcessDefinition

Although the above-mentioned examples illustrate requests for either process instance data or process definition data, in some implementations, requests can include requests for both and the process gateway 109 and/or process resource model engine 109 can appropriately process the request either serially or in parallel. In some implementations, the processing could spawn multiple processes to handle the serial or parallel processing.

In some implementations, the process gateway 108 can wholly or partially parse the received request into appropriate BMPN and/or OData statements as applicable, initiates access to the process resource model 118, and returns data responsive to the request in various formats, for example metadata, Atom Publishing Protocol structure, Hypertext Markup Language (HTML), eXtensible Markup Language (XML), and other suitable documents. In some implementations, the process gateway 108 interfaces with the process resource model engine 109 (described below) to access the process resource model 118. In some implementations, the process resource model engine 109 can parse the originally received request or parse the received request following analysis partial processing/parsing by the process gateway 108.

Although illustrated as internal to the server 102, in some implementations, the process gateway 108 can be wholly or partially external to the server 102, for example as part of a separate gateway server. In some implementations the process gateway 108 can communicate with other process gateways 108 to access process definition and/or process instance data associated with other computing systems and associated process resource models 118.

The server 102 is responsible for receiving requests using the network 130, for example login requests, software selection, configuration, and/or purchase requests from one or more client applications 146 (described below) associated with the client 140 of the example distributed computing system 100 and responding to the received requests by processing said requests in one or more of a content provider manager 107 (described below), the process gateway 108, the a process resource model engine 109 and/or the business application 110. In addition to requests from the client 140, requests may also be sent to the server 102 from internal users, external or third-parties, other automated applications, as well as any other appropriate entities, individuals, systems, or computers.

In some implementations, the process gateway 108 can provide GUI interfaces or interface with the content provider manager to provide GUI interfaces to assist users to request process definition and/or process instance data. For example, an HTTP help query could be issued by a user that when processed by the process gateway 108 results in a returned HTML or other formatted document renderable by a client web browser to provide available HTTP(S) query options.

In some implementations, requests/responses can be sent directly to server 102 from a user accessing server 102 directly. In some implementations, the server 102 may comprise a web server, where one or more of the components of server 102 represent web-based applications accessed and executed by the client 140 using the network 130 or directly at the server 102 to perform the programmed tasks or operations of the various components of server 102.

In some implementations, any and/or all components of the server 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the example distributed computing system 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the example distributed computing system 100, alternative implementations may illustrate the API 112 and/or the service layer 113 as stand-alone components in relation to other components of the example distributed computing system 100. Moreover, any or all parts of the API 112 and/or the service layer 113 may be implemented as child or sub-modules of another software module, enterprise application, or hardware module without departing from the scope of this disclosure.

The server 102 includes an interface 104. Although illustrated as a single interface 104 in FIG. 1, two or more interfaces 104 may be used according to particular needs, desires, or particular implementations of the example distributed computing system 100. The interface 104 is used by the server 102 for communicating with other systems in a distributed environment—including within the example distributed computing system 100—connected to the network 130; for example, the client 140 as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated example distributed computing system 100.

The server 102 includes a processor 105. Although illustrated as a single processor 105 in FIG. 1, two or more processors may be used according to particular needs, desires, or particular implementations of the example distributed computing system 100. Generally, the processor 105 executes instructions and manipulates data to perform the operations of the server 102. Specifically, the processor 105 executes the functionality required to provide a business process visibility resource model.

The server 102 also includes a memory 106 that holds data for the server 102, client 140, and/or other components of the example distributed computing system 102. Although illustrated as a single memory 106 in FIG. 1, two or more memories may be used according to particular needs, desires, or particular implementations of the example distributed computing system 100. While memory 106 is illustrated as an integral component of the server 102, in alternative implementations, memory 106 can be external to the server 102 and/or the example distributed computing system 100. In some implementations, the memory 106, includes one or more instances of process instance data 114, process definition data 116, and/or a process resource model 118.

The process instance data 114 can be any type of data use to identify, classify, and/or describe instances of business processes. The process instance data 114 can be in any suitable format or form, for example, binary, text, numerical, a database file, a flat file, or the like and may be wholly or partially part of the process resource model 118. In some instances the process instance data 114 can be completely independent from the process resource model and accessed through references or the like from the process resource model 118. In some implementations, process instance data 114 is described in an OData compliant data format. For example, process instance data 114 describing a collection of processes returned in response to an HTTP request http://server/servicename/ProcessCollection could be:

| Process ID | Instance |
|---|---|
| 032869 | Start: 20141231 10:14:11:07; Source Hash: |
| | 2348a4d9de369e234af9; Parent: 101838; Children: 000000 |
| 091469 | Start: 20141231 10:14:11:04; Source Hash: |
| | 1afe949e39bc34a114f96; Parent: 101838; Children: 000000 |
| 101838 | Start: 20141231 10:03:06:31; Source Hash: |
| | 001267ab9442e45f710e; Parent: 050170; Children: 032869, |
| | 091469 |
| 050170 | Start: 20141231 09:48:23:42; Source Hash: |
| | 835710a6b35e65611c17; Parent: 060972; Children: 101838 |
| 060972 | Start: 20141231 09:45:01:13; Source Hash: |
| | 934d2043d17ae563471a; Parent: 000000; Children: 050170 |

In some implementations, the process instance data 114 can be searched and/or provide search functionality. In some implementations, the process instance data 114 can directly accessed by any suitable component of the example distributed computing system 100, for example the content provider manager 107, the process gateway 108, the process resource model engine 109, and/or the business application 110. While process instance data 114 is illustrated as an integral component of the memory 106, in alternative implementations, process instance data 114 can be external to the memory 106 and/or be separated into both internal process instance data 114 and external process instance data 114 as long as it is accessible using network 130. In some implementations, the process instance data 114 can act as a reference to an actual other internal and/or external storage location and/or provide functionality to retrieve process instance data 114 stored in the external storage location.

Those of skill in the art will appreciate that the present examples with respect to process instance data 114 are representative only and process instance data 114 could represent myriad types of process-instance-associated data in multiple ways. The provided examples are not meant to be limiting in any way.

The process definition data 116 can be any type of data use to define business processes. The process definition data 116 can be in any suitable format or form, for example, binary, text, numerical, a database file, a flat file, or the like and may be wholly or partially part of the process resource model 118. In some instances the process definition data 116 can be completely independent from the process resource model and accessed through references or the like from the process resource model 118. In some implementations, process definition data 118 is described in a BPMN-compliant data format. For example, BPMN-compliant process definition data 116 describing a collection of processes returned in response to an HTTP request:

http://server/servicename/ProcessCollection

could be BPMN XML data defining one or more aspects of a process and/or process step as a process model.

In some implementations, the process definition data 116 can be searched and/or provide search functionality. In some implementations, the process definition data 116 can directly accessed by any suitable component of the example distributed computing system 100, for example the content provider manager 107, the process gateway 108, the process resource model engine 109, and/or the business application 110. While process definition data 116 is illustrated as an integral component of the memory 106, in alternative implementations, process definition data 116 can be external to the memory 106 and/or be separated into both internal process definition data 116 and external process definition data 116 as long as it is accessible using network 130. In some implementations, the process definition data 116 can act as a reference to an actual other internal and/or external storage location and/or provide functionality to retrieve process definition data 116 stored in the external storage location.

Those of skill in the art will appreciate that the present example with respect to process definition data 116 is representative only and process definition data 116 could represent myriad types of process-definition-associated data in multiple ways. The provided examples are not meant to be limiting in any way.

The process resource model 118 is an object entity model combining and leveraging OData to describe process instance type data at the runtime level and BPMN to describe process definition type data at the definition level. The process resource model 118 can be consumed by process developers (or developer tools) to build and/or generate applications of different types that consume process related information. For example, applications can be web applications, mobile applications, development applications, and the like that have a need to consume either process instance data 114 and/or process definition data 116 as described above.

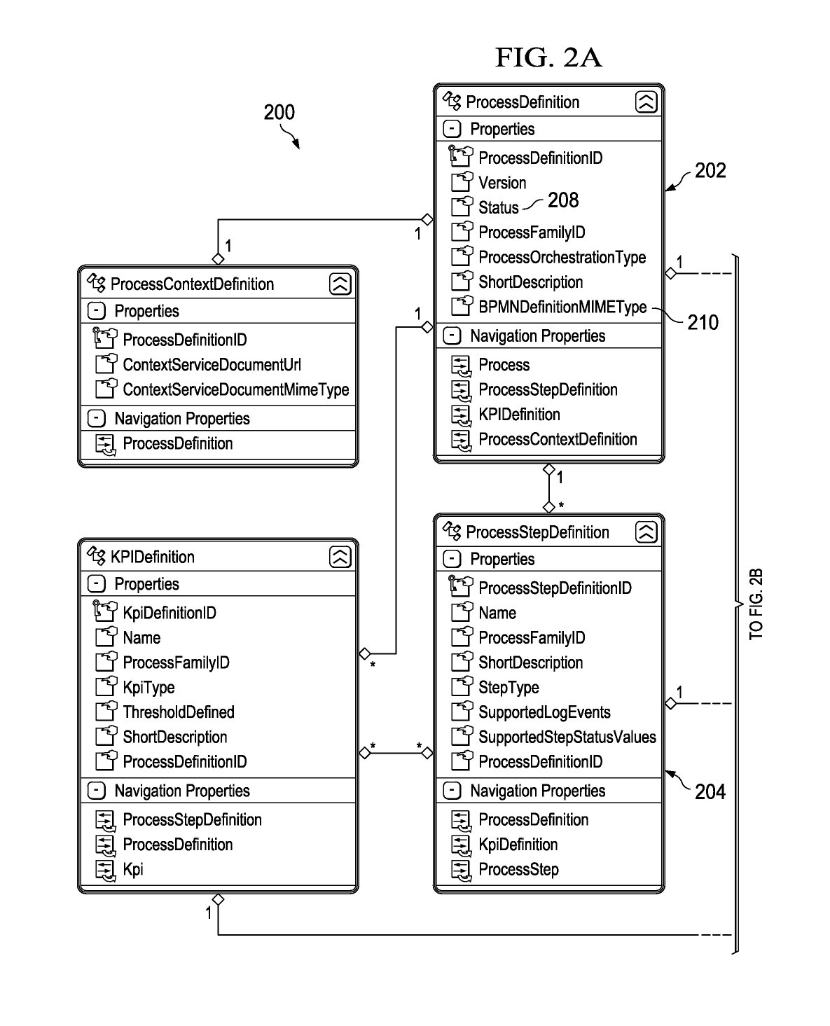

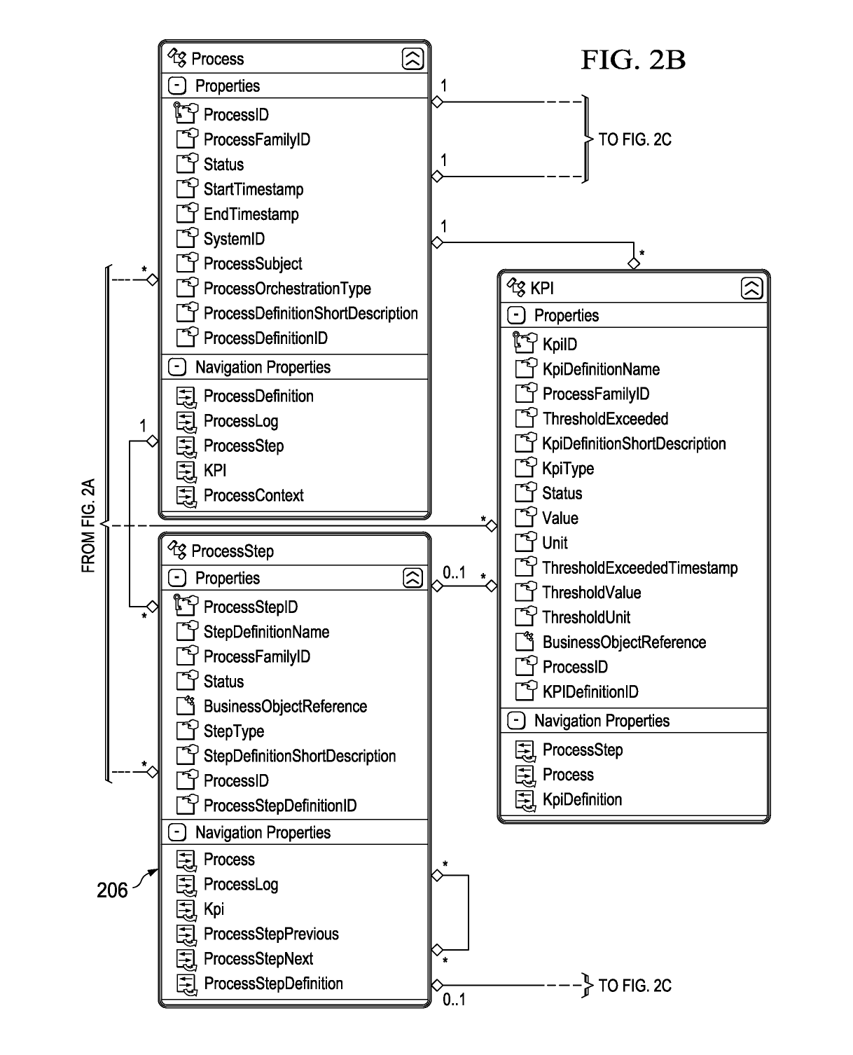

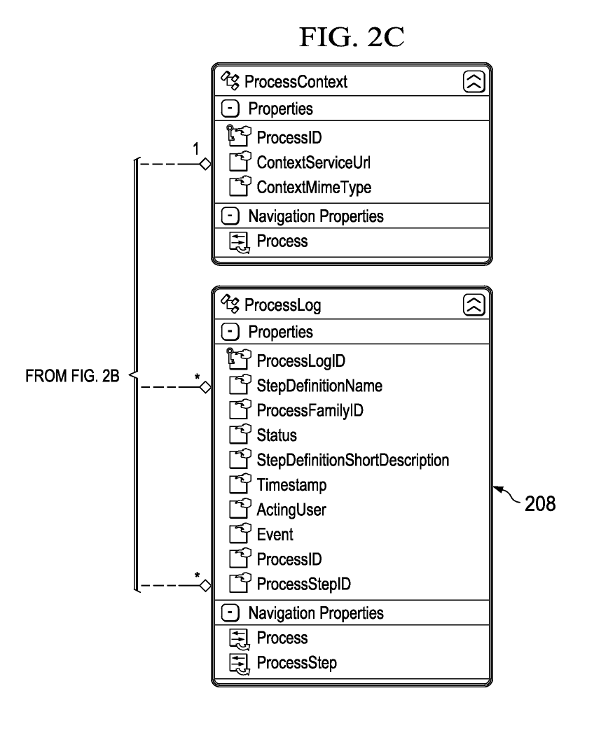

FIGS. 2A-2C are block diagrams illustrating an example process resource model 200 according to one implementation. Referring to FIG. 2A, the process resource model 200 is made up of multiple objects each providing both properties and navigation properties. For example, object 202 provides process definitions while object 204 provides process step definitions. Other objects store/provide access to various aspects of a process and/or process steps. For example, object 206 as illustrated in FIG. 2B stores/provides data associated with process steps and object 208 as illustrated in FIG. 2C stores/provides data associated with process logs.

In some implementations, the process resource model 200 is an OData-based entity consumption model describing entities related to a process instance and/or a process step instance. Built into the process resource model 200 is a navigation capability expressed as a “media link” that allows access to a BPMN representation of a process definition. In some implementations, the BPMN representation of the process definition is expressed as a BPMN XML document. For example, the user could request BPMN process definition data as a BPMN XML document by making an HTTP request of:

http://server/servicename/ProcessDefinitionCollection(Id‘1234’)/$value

The retrieved BPMN representation of a process definition for process ID=1234 is then returned to the user through the process gateway 108 as a BPMN XML document for consumption by the user.

In some implementations, embedded within the example process resource model 200 in object 202 is a BPMNDefinitionMIMEType property 206. If a user wishes to obtain process definition data 116 about a process and/or process steps, a received HTTP(S) query received by the process gateway 108 for process definition data 116 through the client 140 can be parsed by the process resource model engine 109 and appropriate BPMN data for the desired process definition data 116 is returned to the user. In these implementations, the process resource model engine 109 is configured to access the BPMNDefinitionMIMEType property 206 to retrieve the BPMN data. This BPMN data can be further processed by either the process resource model engine 109 and/or the process gateway 108 to return to the user the particularly requested process definition data 116, possibly as a BPMN XML document, through the process gateway 108.

If a user wishes to obtain process instance data 114 about a process and/or process steps, a received HTTP(S) query received by the process gateway for process instance data 114 through the client 140 can be parsed by the process resource model engine 109 and the appropriate OData data returned to the user. The process resource model engine 109 is configured to access the appropriate properties and/or navigation properties associated with the proper object(s) in the process resource model to obtain the appropriate user requested process instance data 114. For example, the process resource model engine 109 may access the “Status” property 208 to retrieve process instance data 114 related to an HTTP query requesting a list of all processes with a status of “Complete”:

http://server/servicename/ProcessCollection?$filter=Status eq ‘Completed’

The retrieved OData process instance data 114 for processes that have a status of “completed” is then returned to the user through the process gateway 108 as OData for consumption by the user.

Returning to FIG. 1, the content provider manager 107 is any type of application that allows the client 140 to request and view content on the client 140 after obtaining content from the server 102 and/or a content provider (not illustrated) in response to a received request from the client 140. A content provider may be, for example, applications and data on the server 102 and/or external services, business applications, business application servers, databases, RSS feeds, document servers, web servers, streaming servers, caching servers, or other suitable content sources. In some implementations, the content provider manager 107 enables the consumption of content provider content by client 140. In some implementations, the content provider manager 107 allows connections to various content providers, queries the content provider with regards to provided content, and enables a user to view, add, edit, and/or delete content associated with the server 102.

In some implementations, the content provider manager 107 can also use content provider manager data (not illustrated) including content provider locations, addresses, storage specifications, content lists, access requirements, or other suitable data. For example, for a database content provider, the content provider manager data may include the server Internet Protocol (IP) address, URL, access permission requirements, data download speed specifications, etc. associated with the database content provider.

Once a particular content provider manager 107 is launched, a client 140 may interactively process a task, event, or other information associated with the server 102. The content provider manager 107 can be any application, program, module, process, or other software that may execute, change, delete, generate, or otherwise manage information associated with a particular client 140. For example, the content provider manager 107 may be a portal application, a business application, and/or other suitable application consistent with this disclosure. The content provider manager can interface with the process gateway 108, process resource model engine 109, and/or the business application 110.

Additionally, a particular content provider manager 107 may operate in response to and in connection with at least one request received from other content provider managers 107, including a content provider manager 107 or other component (e.g., software and/or hardware modules) associated with another server 102. In some implementations, the content provider manager 107 can be and/or include a web browser. In some implementations, each content provider manager 107 can represent a network-based application accessed and executed using the network 130 (e.g., through the Internet, or using at least one cloud-based service associated with the content provider manager 107). For example, a portion of a particular content provider manager 107 may be a web service associated with the content provider manager 107 that is remotely called, while another portion of the content provider manager 107 may be an interface object or agent bundled for processing at a remote client 140. Moreover, any or all of a particular content provider manager 107 may be a child or sub-module of another software module or enterprise application (not illustrated) without departing from the scope of this disclosure. Still further, portions of the particular content provider manager 107 may be executed or accessed by a user working directly at the server 102, as well as remotely at a corresponding client 140. In some implementations, the server 102 can execute the content provider manager 107.

The process resource model engine 109 can be any application, program, module, process, or other software to interface with the content provider manager 107, process gateway 108, business application 110, process resource model 118, process definition data 116, and/or process instance data 114 to provide process instance data 114 and/or process definition data 116 in response to user HTTP(S) requests through a client 140. The process resource model engine 109 parses received user HTTP(S) requests into appropriately formatted requests to retrieve data from the process resource model 118 and returns OData and/or BPMN data to the requesting user depending on the type of process data requested. In some implementations, the process resource model engine 109 can modify the process instance data 114, process definition data 116, and/or the process resource model 118.

A particular process resource model engine 109 may operate in response to and in connection with at least one request received from other process resource model engines 109, including a process resource model engine 109 associated with another server 102. In some implementations, the process resource model engine 109 can include a web browser. In some implementations, each process resource model engine 109 can represent a network-based application accessed and executed using the network 130 (e.g., through the Internet, or using at least one cloud-based service associated with the process resource model engine 109). For example, a portion of a particular process resource model engine 109′ may be a web service associated with the process resource model engine 109 that is remotely called, while another portion of the process resource model engine 109 may be an interface object or agent bundled for processing at a remote client 140. Moreover, any or all of a particular process resource model engine 109 may be a child or sub-module of another software module or enterprise application (not illustrated) without departing from the scope of this disclosure. Still further, all or portions of the particular process resource model engine 109 may be executed or accessed by a user working directly at the server 102, as well as remotely at a corresponding client 140.

The client 140 may be any computing device operable to connect to or communicate with at least the server 102 using the network 130. In general, the client 140 comprises an electronic computing device operable to receive, transmit, process, and store any appropriate data associated with the example distributed computing system 100. The client includes a processor 144, a client application 146, a memory 148, and/or an interface 148.

The client application 146 is any type of application that allows the client 140 to navigate to/from, request, view, edit, delete, and or manipulate content on the client 140. In some implementations, the client application 146 can be and/or include a web browser. In some implementations, the client-application 146 can use parameters, metadata, and other information received at launch to access a particular set of data from the server 102. Once a particular client application 146 is launched, a user may interactively process a task, event, or other information associated with the server 102. Further, although illustrated as a single client application 146, the client application 146 may be implemented as multiple client applications in the client 140. In some implementations, the client application 146 may act as a GUI interface for the content provider manager 107 and/or other components of server 102 and/or other components of the example distributed computing environment 100.

The interface 149 is used by the client 140 for communicating with other computing systems in a distributed computing system environment, including within the example distributed computing system 100, using network 130. For example, the client 140 uses the interface to communicate with the server 102 as well as other systems (not illustrated) that are communicably coupled to the network 130. The interface 149 may be consistent with the above-described interface 104 of the enterprise server 102 or other interfaces within the example distributed computing system 100. The processor 144 may be consistent with the above-described processor 105 of the server 102 or other processors within the example distributed computing system 100. Specifically, the processor 144 executes instructions and manipulates data to perform the operations of the client 140, including the functionality required to send requests to the server 102 and to receive and process responses from the server 102. The memory 148 may be consistent with the above-described memory 106 of the server 102 or other memories within the example distributed computing system 100 but storing objects and/or data associated with the purposes of the client 140, including process instance data 114, process definition data 116, a process resource model 118 similar to that stored in memory 106 of server 102. In some implementations, the memory 148 may be used by server 102 to store objects and/or data.

Further, the illustrated client 140 includes a GUI 142. The GUI 142 interfaces with at least a portion of the example distributed computing system 100 for any suitable purpose, including generating a visual representation of a web browser. The GUI 142 may be used to view and navigate various web pages located both internally and externally to the server 102. In particular, the GUI 142 may be used in conjunction with content from server 102 to provide access and interactions with the process resource model 118.

There may be any number of clients 140 associated with, or external to, the example distributed computing system 100. For example, while the illustrated example distributed computing system 100 includes one client 140 communicably coupled to the server 102 using network 130, alternative implementations of the example distributed computing system 100 may include any number of clients 140 suitable to the purposes of the example distributed computing system 100. Additionally, there may also be one or more additional clients 140 external to the illustrated portion of the example distributed computing system 100 that are capable of interacting with the example distributed computing system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142, as shown with respect to the client 140.

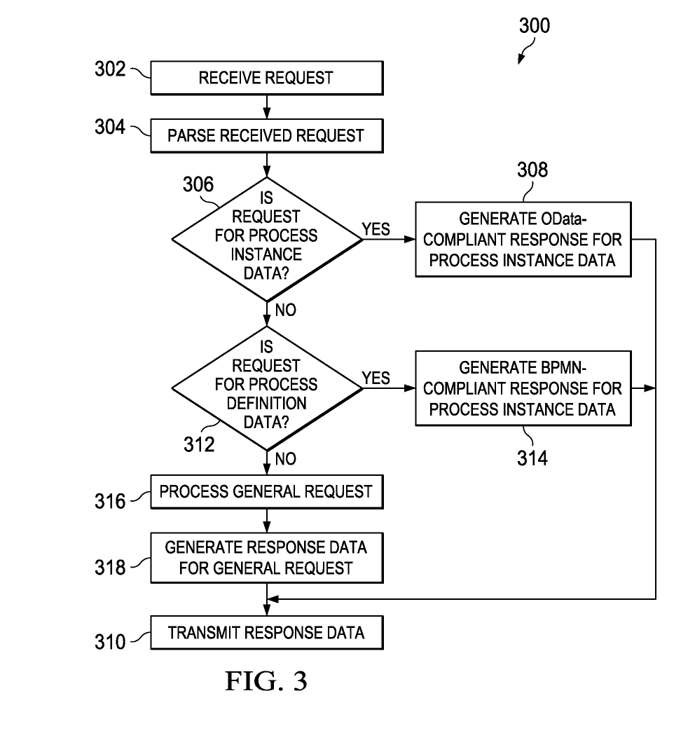

FIG. 3 is a flow chart illustrating a method for interfacing and obtaining process data from a process resource model. For clarity of presentation, the description that follows generally describes method 300 in the context of FIGS. 1-2. However, it will be understood that method 300 may be performed, for example, by any other suitable system, environment, software, and hardware, or a combination of systems, environments, software, and hardware as appropriate.

At 302, a request is received for process instance data and/or process definition data. In some implementations, other data may be passed along with the request. For example, user name, ID, security token, etc. From 302, method 300 proceeds to 304.

At 304, the received request is parsed to determine the type of process data desired as well as to recover request parameters used to retrieve the data from the process resource model. From 304, method 300 proceeds to 306.

At 306, a determination is made whether the request was for process instance data. If at 306 it is determined that the request was for process instance data, method 300 proceeds to 308. If at 306, it is determined that the request was not for process instance data, method 300 proceeds to 312.

At 308, an OData-compliant response is generated to return process instance data to the requestor if appropriate. From 308, method 300 proceeds to 310.

At 310, the response data is transmitted to the requestor. After 310, method 300 stops.

At 312, a determination is made whether the request was for process definition data. If at 312 it is determined that the request was for process definition data, method 300 proceeds to 314. If at 312, it is determined that the request was not for process instance data, method 300 proceeds to 316.

At 314, a BPMN-compliant response is generated to return process definition data to the requestor if appropriate. From 314, method 300 proceeds to 310.

At 316, the general request is processed. From 316, method 300 proceeds to 318.

At 318, a general response is generated to return general response data to the requestor if appropriate. From 314, method 300 proceeds to 310.

In some implementations, various steps of method 300 can be run in parallel, in combination, in loops, or in any order. For example, the parsing of the received request at 304 may include a request for both process instance data and process definition data. In this instance, the parsing can spawn multiple copies of method 300 to handle each response in parallel or in any manner suitable to handle the multiple requests in an efficient manner.

FIGS. 1, 2A-2C, and 3 illustrate and describe various aspects of computer-implemented methods, computer-readable media, and computer systems for providing a business process visibility resource model. While the disclosure discusses the processes in terms of business process, as will be apparent to one of skill in the art, processes can also be considered to be any type of process and the use of business processes in the disclosure is not meant to limit the applicability of the disclosure in any way.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a request for process data from a client device;
parsing the received request to determine a type of process data to return and to recover request parameters;
determining the type of process data requested;
accessing a process resource model and retrieving process data based upon the recovered request parameters;
generating a response returning data in a format compliant with the type of process data requested; and
transmitting the generated response data.

2. The method of claim 1, wherein the type of process data is one of process instance data or process definition data.

3. The method of claim 1, wherein the process resource model is an OData-based consumption entity model including a BPMN media link.

4. The method of claim 3, further comprising:
requesting process definition data using a BPMN media link attribute; and
receiving BMPN-compliant response data.

5. The method of claim 1, wherein the determination of the type of process data requested results in process instance data.

6. The method of claim 5, further comprising generating an OData-compliant response to the received request.

7. The method of claim 1, wherein the determination of the type of process data requested results in process definition data.

8. The method of claim 7, further comprising generating a BPMN-compliant response to the received request.

9. A non-transitory, computer-readable medium storing computer-readable instructions executable by a computer to:
receive a request for process data from a client device;
parse the received request to determine a type of process data to return and to recover request parameters;
determine the type of process data requested;
access a process resource model and retrieving process data based upon the recovered request parameters;
generate a response returning data in a format compliant with the type of process data requested; and
transmit the generated response data.

10. The medium of claim 9, wherein the type of process data is one of process instance data or process definition data.

11. The medium of claim 9, wherein the process resource model is an OData-based consumption entity model including a BPMN media link.

12. The medium of claim 11, further comprising instructions to:
request process definition data using a BPMN media link attribute; and
receive BMPN-compliant response data.

13. The medium of claim 9, wherein the determination of the type of process data requested results in process instance data.

14. The medium of claim 13, further comprising instructions to generate an OData-compliant response to the received request.

15. The medium of claim 9, wherein the determination of the type of process data requested results in process definition data.

16. The medium of claim 15, further comprising instructions to generate a BPMN-compliant response to the received request.

17. A computer system, comprising:
at least one computer configured to:
receive a request for process data from a client device;
parse the received request to determine a type of process data to return and to recover request parameters;
determine the type of process data requested;
access a process resource model and retrieving process data based upon the recovered request parameters;
generate a response returning data in a format compliant with the type of process data requested; and
transmit the generated response data.

18. The system of claim 17, wherein the type of process data is one of process instance data or process definition data.

19. The system of claim 17, wherein the process resource model is an OData-based consumption entity model including a BPMN media link.

20. The system of claim 19, further configured to:
request process definition data using a BPMN media link attribute; and
receive BMPN-compliant response data.

21. The system of claim 17, wherein the determination of the type of process data requested results in process instance data.

22. The system of claim 21, further configured to generate an OData-compliant response to the received request.

23. The system of claim 17, wherein the determination of the type of process data requested results in process definition data.

24. The system of claim 23, further configured to generate a BPMN-compliant response to the received request.
